(19) United States
(12) Patent Application Publication
(10) Pub. No.: US 2012/0304208 A1
(43) Pub. Date: Nov. 29, 2012

(54) Targeted television advertisement and television programming control apparatus, system and method

(76) Inventor: Thomas J. McWilliams, Bryn Mawr, PA (US)

(21) Appl. No.: 13/136,952

(22) Filed: Aug. 15, 2011

Related U.S. Application Data
(60) Provisional application No. 61/402,210, filed on Aug. 25, 2010.

(51) Int. Cl. H04N 21/442

(52) U.S. Cl. 725/14

(57) ABSTRACT

A targeted television advertisement and television programming control apparatus, system and method, may include a biometric viewer tracker, a programming tracking server, and an advertisement server.

This application claims the benefit of priority of U.S. Provisional Application Ser. No. 61/402,210, entitled A TARGETED TELEVISION ADVERTISEMENT AND TELEVISION PROGRAMMING CONTROL APPARATUS, SYSTEM AND METHOD, filed on Aug. 25, 2010 by inventor Thomas J. McWilliams.

### BACKGROUND OF THE INVENTION

1. Field of the Invention

The present invention is directed to television programming, and, more particularly, to a targeted television advertisement and television programming control apparatus, system and method.

2. Description of the Background

It will be appreciated by those skilled in the art that viewership, and particularly television viewership, is presently monitored in a few, limited ways. More particularly, the Nielson rating system tracks television viewing based on surveys of television viewers—that is, viewers are asked, electronically or in paper form, to submit information regarding the identity of the viewers in a particular household at a given time, and what those viewers are viewing at that given time. However, such viewership tracking mechanisms are often inadequate for a number of reasons.

Typical viewership tracking is presently inadequate because viewers may fail to submit information regarding viewership at particular times, such as due to forgetfulness, for example. Further, viewers may wish to “go with the crowd,” and consequently may submit viewership information that claims viewership of the most popular shows on at a given time, irrespective of what the viewer is actually watching. Alternatively, viewers may simply be embarrassed of what it is they are watching, or may, for any of a variety of other reasons, provide incorrect information with regard to what is being watched, and/or who it is that is watching, at a given time. For example, viewers may not wish to submit that a 5 year old child is watching a mature audience, violent program at 10:30 pm on a Thursday night.

Nevertheless, current methods of providing television programming to viewers, such as via cable and satellite networks, typically employ the provision of programming via, for example, a set top box (STB), an Internet protocol television (IPTV), or the like. Such devices may have associated therewith infrared sensors that may indicate the presence of one or more beings in the room with the device. Further, often information with regard to viewership occurring on such devices that help provide the programming to viewers is monitored, such as at one or more local servers, such as at one or more edge servers in a cable programming network, for example. Such programming information, if mated with certain profile information with regard to households in which viewership is occurring and/or with infrared-sensed information, may provide information akin to internet metadata, or “cookies” (user-information provided on the worldwide web regarding internet surfing), but with respect to television viewing rather than Internet surfing.

Further, certain modern devices, such as Microsoft's Kinect, not only allow for the metadata-like use of tracked viewership information, but further directly provide an assessment, such as using biometrics, profiling persons viewing a television at any given time. For example, such devices may include facial recognition, fingerprint recognition, infrared sensing, voice recognition, and the like. Such information may be used not only in the playing of video games, but may additionally may be mated with information tracked regarding what is being viewed on the television at the particular time, and who is in front of the television at the particular time.

Thus, the need exists for an apparatus, system and method that uses improved tracking information to provide programming control and/or targeted advertising.

### SUMMARY OF THE INVENTION

In two particular instances, namely a first instance in which viewing information with regard to particular households is tracked in a metadata-like manner using, for example, STBs, and a second instance in which this metadata-like tracking may or may not occur but in which a biometric tracking of viewers at any given time is monitored, the present invention provides advantageous aspects based on improved viewer tracking. These advantages include at least programming control based on a current viewer or viewers, and targeted advertising based on a viewer or viewers.

Thus, the present invention provides an apparatus, system and method that use improved tracking information to provide programming control and/or targeted advertising.

### BRIEF DESCRIPTION OF THE DRAWINGS

Understanding of the disclosure will be facilitated by consideration of the following detailed description of the embodiments, taken in conjunction with the accompanying drawings, in which like numerals refer to like parts and in which:

FIG. 1 is a block diagram illustrating aspects of the present invention;

FIG. 2 is a block diagram illustrating aspects of the present invention;

FIG. 3 is a flow diagram illustrating aspects of the present invention; and

FIG. 4 is a flow diagram illustrating aspects of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical telecommunication apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

Methods of providing television programming to viewers, such as via cable and satellite networks, typically employ the provision of programming via, for example, a set top box (STB), an internet protocol television (IPTV), or the like. Often, information with regard to viewership occurring through the devices that provide the programming to views is monitored, such as at one or more local servers, such as at one or more edge servers in a cable programming network, for example.

Further, certain modern devices assess the biometrics of persons viewing a television at any given time. For example, such devices may include facial recognition, fingerprint recognition, infrared sensing, voice recognition, and alike, which information may be used not only in the playing of video games, but which additionally may be mated with information tracked regarding what is being viewed on the television at the particular time that a person is tracked as in front of the television.

In a first instance in which viewing information with regard to particular households is tracked using, for example, STBs, and in a second instance in which a biometric tracking of viewers at any given time is monitored, the present invention provides at least programming control based on a current viewer or viewers, and targeted advertising based on a viewer or viewers.

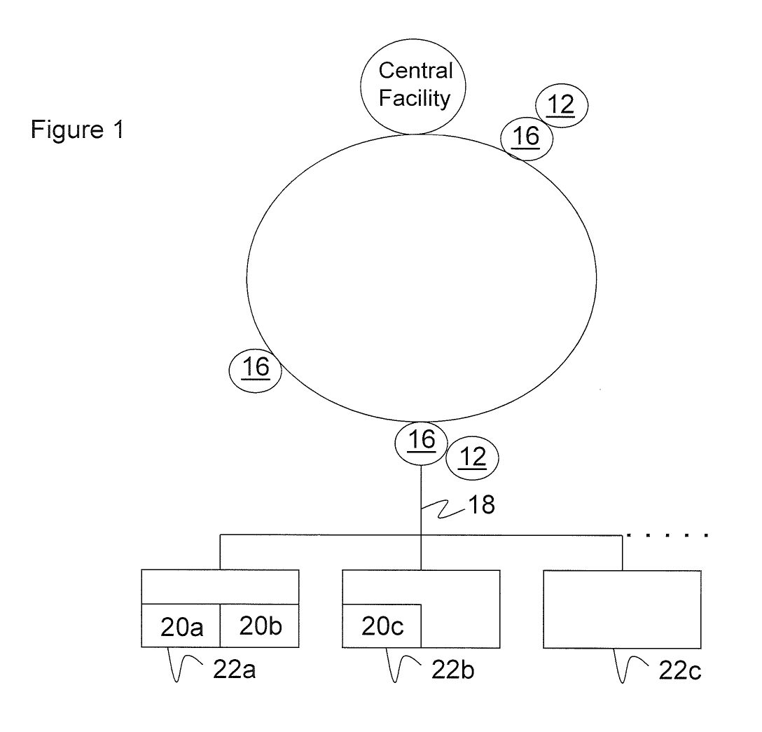

More particularly, FIG. 1 illustrates the association of a tracking server 12 with, for example, one or more local servers 16, such as one or more edge servers, for the monitoring and tracking of television viewership. More particularly, the illustrated tracking server 12 preferably receives viewership information 18 with regard to one or more televisions 20a, 20b, 20c in a plurality of households 22a, 22b, 22c. More particularly, this tracked viewership information may include viewing habits at particular times of day for viewing devices, such as for the STBs, IPTVs, and the like (hereinafter STBs) assigned to the particular household, and/or biometric information regarding viewers of particular televisions within the households at particular times of day. Further, the tracking server may independently track viewership information and biometrics, or may relationally track viewership information in conjunction with biometrics information, or may track only one of viewership information or biometric information, such as for houses having devices equipped to only provide one aspect of such information items. Further, a tracking server may instruct action based on accumulated tracked information as discussed above, or may instruct action based on real time information provided to the tracking server. The tracking server may be of any server type known to those skilled in the art, and, notwithstanding the exemplary illustration of FIG. 1, may be, may be part of, and/or may be communicatively connected to local server 16.

Thus, the tracking server illustrated in FIG. 1, in conjunction with the remainder of a programming provision network, may allow for control over available programming at one or more devices within each of the plurality of households discussed above, such as in real time or at particular times of day. More specifically, biometric tracking of persons in front of each television within an exemplary one of the households may allow for only age appropriate programming to be available to ones of, or each of, the televisions in that household. Likewise, tracking of viewership information, in conjunction with or independently from tracking of biometric information, may provide, such as over a tracked time period, an indication of which persons are typically in front of which televisions at certain times of day, such as based on channels viewed, programs viewed, and the like.

By way of specific example, biometric tracking may indicate that at 9:30 am, in a household including (such as according to an account profile known to a programming provider/enabler) a father of age 36, a mother of age 34, an eldest child of age 12, a middle child of age 6, and a youngest child of age 3, the mother is before a kitchen television set, while the 3-year old child is before the living room television set. Thereby, the tracking server may indicate that, while all programming is to be available on the kitchen television set, based on the mother's age, only age appropriate material for those of age 5 and under may be made available on the living room television set. Further, the living room television set may have various other services indicated, such as blocking of purchase of on-demand items, or channel changes responsive only to entry of certain key codes, to thus prevent the 3-year old child from picking up the remote and making an undesired purchase, or from changing to a channel that either does not have age appropriate content for the child, or that will confuse or upset the child because the child has mistakenly turned off a favorite show.

Further to this example, later that same day, such as at 8:30 pm, the tracking server may receive a biometric indication that only the living room television is active, and the 12-year old and 6-year old children are then viewing that television. In such a circumstance, it may be most desirable to have only age appropriate programming available for the 6-year old, rather than indicating age appropriateness by the older viewer, namely the 12-year old, although the 12-year old may have certain override privileges, which override privileges may rise to that of the parents by entry of a parent key code, for example, or which override privileges may be different than a parent, and perhaps may offer lesser override programming that is only age appropriate for a 12-year old child. Thus, the present invention may provide varying programming, such as varying lineups, to a respective device based on then-current viewership of that device, or based on any number of other factors with regard to the viewers.

It goes without saying that the foregoing exemplary embodiment may make use of more limited tracked information, such as in embodiments in which such limited information is the only information available. For example, tracked viewership of the television in the kitchen in the example may indicate that, at 9:30 am on a typical weekday, tracked viewing information indicates that it is most likely to be the mother that is watching the kitchen television. For example, the weekday viewership typically occurring at 9:30 am on a weekday may include talk shows, soap operas, or other programming having a highest viewership among females between 33 years old and 45 years old. Thereby, if one of those programs is then-being viewed in the kitchen, it is most likely the mother that is watching that program.

Correspondingly, information may indicate that, on a weekday at 9:30, a child under 5 is the most likely viewer of the programming typically displayed on the living room television. This age estimate for viewership may be further refined using other information external to the programming system, such as an indication from a local school schedule available over the Internet that school is in session on the weekday in question—thus indicating that, if children's programming is then-being viewed, and the household includes 3, 6 and 12 year old kids, it is more likely than not that the 6 and 12 year olds are at school, and thus it is most likely that the child watching the living room programming for children is the 3 year old child.

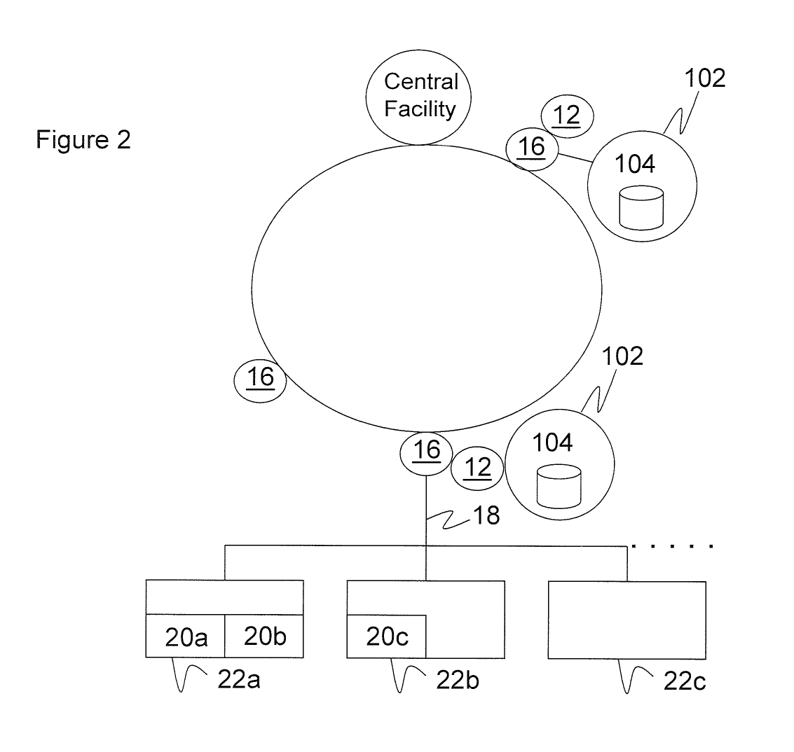

Additionally, and as illustrated in FIG. 2, an advertising server 102 may be associated with the tracking server discussed in FIG. 1. The illustrated advertising server may provide advertisements 104 that are targeted to viewers of televisions in particular households, either in real time or based on accumulated data. As illustrated, the advertising server may be directly associated with a local server 16, such as an edge server, or may be associated with the network through the tracking server.

In accordance with this exemplary embodiment, television programming may be provided with, for example, indicators associated with each advertisement, or each advertising slot, wherein such indicators may indicate, for example, summary of content of the spot, age appropriateness of the spot, or an emptiness in the slot. Thereby, the advertising server illustrated may insert or replace an advertisement based on factors associated with the viewer of the television on which the advertisement is to be provided. For example, in the illustration above, an empty slot blocked in the programming stream for an advertisement may have inserted therein an advertisement for a toy that is age appropriate to the 3-year old for display on the television in the living room that is being watched by the 3-year old at 9:30 am. However, in the event that the mother is in the kitchen watching the same program as the child, the tracking server may indicate that a different advertisement is to be produced, targeted to the mother, in the same empty slot on the TV in the kitchen that is being viewed by the mother. Further, in the event the mother and 3-year old child are viewing the same program, and an advertisement is placed in the programming that is age appropriate only for those 8 and up, the mother may receive the original slotted advertisement, while the 3-year old child may, in a different room, receive a different advertisement that has been inserted to replace the original advertisement because the original advertisement is not age appropriate for the 3-year old child.

Needless to say, placement of advertisements in this manner may be allowed for by a late stage bind (herein defined to include a binding of one content, in this case an advertisement, to other content, in this case a program, at a “late stage” of serving the program, i.e., just as the program is served from the local server to the household) of the advertisement to the programming as the programming is placed to the household, such as binding by the advertising server local to the household in association with the regional edge server serving that household. As used herein, a late stage bind may indicate that the advertisement or advertisements are inserted into programming not upon generation of the programming, and not upon receipt of the programming at the head end or central facility of the network, but rather are inserted only as the programming is placed into the particular household of interest. As such, this late stage bind does not include programming that includes advertising as the programming is received at a main facility of the programming service provider, and further does not include programming to which is bound advertisements as indicated to the main facility upon receipt of the programming at the main facility.

Thus, the present invention may provide television advertisements in a manner similar to the advertisements provided on satellite radio, such as when satellite radio is locally received with an empty spot, and into that empty spot is inserted a local advertisement relevant to the locality in which that satellite broadcast will be received. Similarly, the present invention allows, such as for cable or satellite network embodiments, the insertion of advertisements in real time as outgoing programming is generated, produced, or placed from a cable or satellite hub to local users, wherein the advertisements may be relevant to any factor, such as the geography in which the programming is received, or such as age appropriateness of the advertisements as discussed in the example immediately hereinabove.

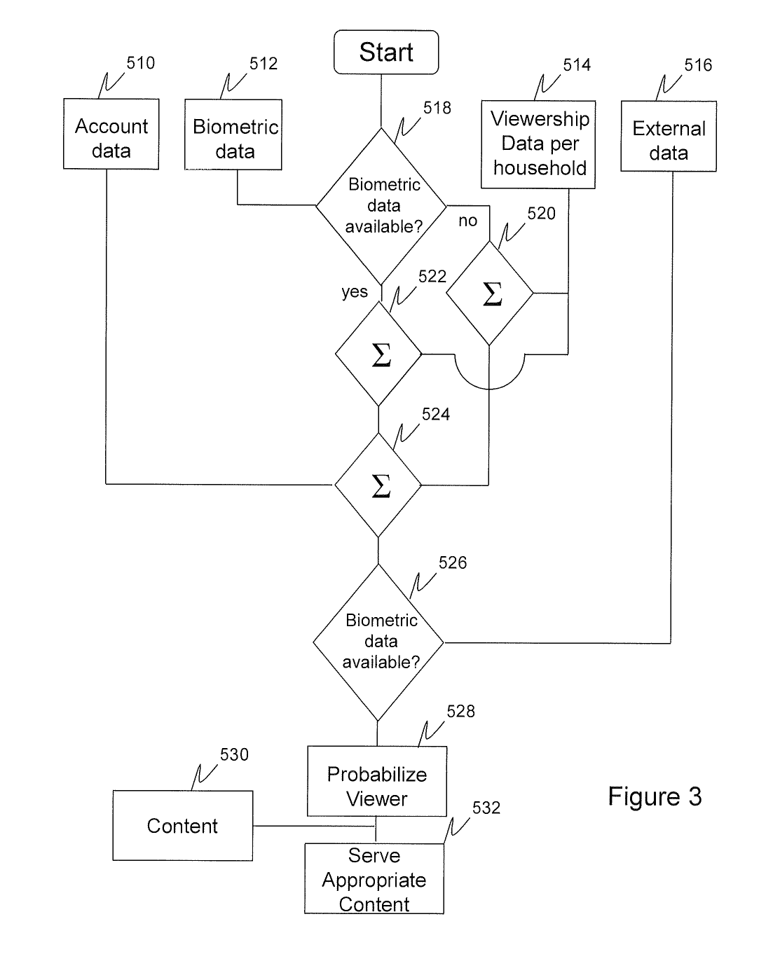

Of course, as referenced hereinabove, in certain embodiments biometric information may or may not be readily available, as is illustrated more particularly in the flow diagram of FIG. 3. In a circumstance in which biometric information is not available, the metadata-like capabilities of the tracking server may allow, such as over a period of time, for the monitoring of viewership of each television within a particular household. More particularly, the viewership of particular televisions in total, by average, by hour of the day, and the like, may be modeled from tracking server data. Therefrom, it may be indicated that, in the aforementioned example, a child likely between the ages of 2 and 6 is typically viewing a television in the living room of the subject household between 8 am and 11 am daily. Pursuant to this estimation, the features discussed herein, namely the programming control and/or advertising insertion, may be provided in an age appropriate manner based on the model data.

Further, as discussed throughout, the union of biometric and metadata-like data may provide the strongest indication for programming control, and/or advertising production. This union of data may provide ideal tracking information far better than that presently available from, for example, Neilson ratings.

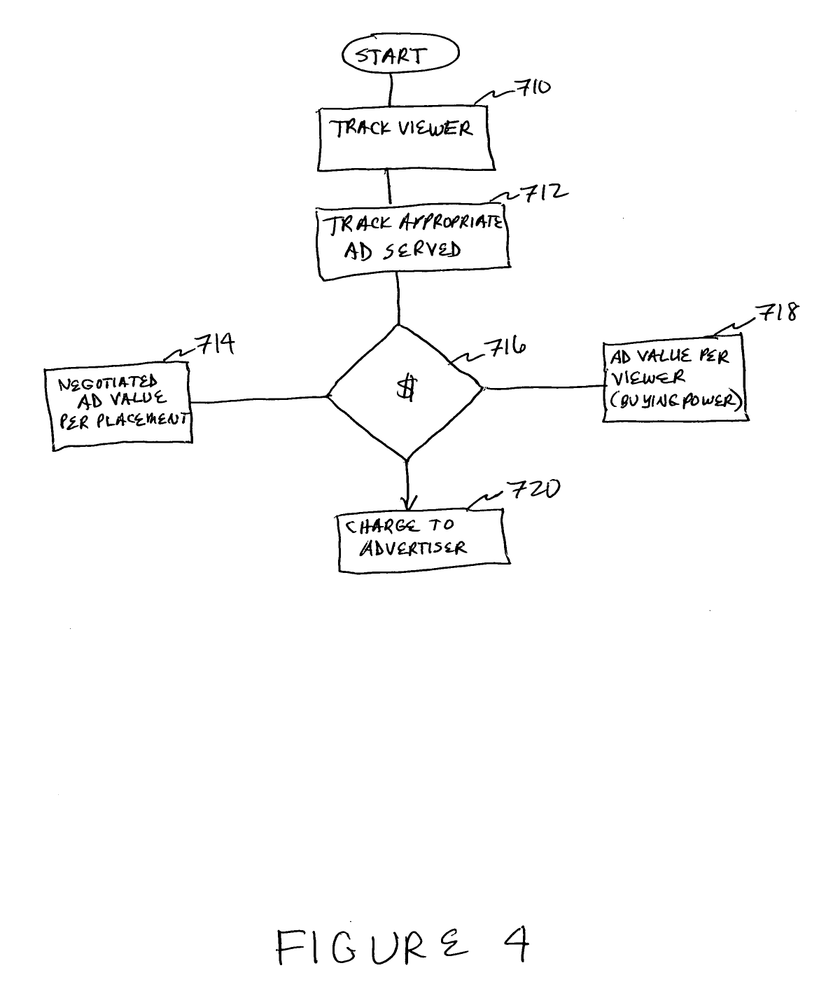

Moreover, those skilled in the art will appreciate, in light of the discussion herein, that a variable pricing model for advertisements in association with television programming, such as that illustrated in the flow diagram of FIG. 4, may be indicated by the present invention. For example, in a manner akin to the production of advertisements on the worldwide web, wherein views, clicks, and/or click-throughs are monitored for advertisement pricing, advertisers may be asked to pay in the present invention for each placement, or average number of placements, of advertisements, in part because advertisements may not be pre-bound with the programming information as is the case in the current art. Rather, the later stage binding of the advertisements into the programming may allow for more highly targeted, but variable, placement of the advertisement based on certain geographies, certain times of day, and the like.

Further, the elements and actions discussed herein may preferably be embodied in computing hardware and software, and may be operable over one or more telecommunications networks, such as at one or more nodes of a network. Thus, aspects of the present invention may be associated with one or more computer storage mechanisms, and may be executed by one or more computing processors.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. A television programming control system, comprising:
a biometric viewer tracker;
at least one tracking server associated with a plurality of households, wherein said at least one tracking server receives viewing information for each of the plurality of households and output information from said biometric viewer tracker; and
a programming controller that limits available programming to at least one of the plurality of households in accordance with at least one indication regarding a viewer in the at least one of the plurality of households from said at least one tracking server.

2. A targeted television advertisement system, comprising:
a biometric viewer tracker;
at least one tracking server associated with a plurality of households, wherein said at least one tracking server receives viewing information for each of the plurality of households and output information from said biometric viewer tracker; and
at least one advertisement server that assesses at least open advertisement slots in a program viewed in at least one of the plurality of households according to said at least one tracking server, and that inserts into one of the open advertisement slots an advertisement appropriate to a viewer of the program viewed according to an indication from said at least one tracking server.

3. A targeted television advertisement system, comprising:
at least one tracking server communicatively connected to each of a plurality of households, wherein said at least one tracking server receives viewing information by at least channel and time for each of the plurality of households; and
at least one advertisement server that assesses at least open advertisement slots in a program viewed in at least one of the plurality of households, and that inserts into one of the open advertisement slots an advertisement appropriate to a viewer of the program viewed according to an indication of appropriateness from said at least one tracking server.
